(19) United States
(12) Patent Application Publication
(10) Pub. No.: US 2026/0064630 A1
(43) Pub. Date: Mar. 5, 2026

(54) MANAGING RETENTION OF LOGS

(71) Applicant: Honeywell International Inc., Charlotte, NC (US)

(72) Inventor: Ankit Singh, Apex, NC (US)

(21) Appl. No.: 18/822,500

(22) Filed: Sep. 3, 2024

(51) Int. Cl. G06F 16/11; G06F 16/18

(52) U.S. Cl. CPC G06F 16/125; G06F 16/1805

(57) ABSTRACT

Approaches for managing retention of logs are described. In an example, a log pertaining to an operation and/or development of a product and/or service is obtained. The log is processed to determine log attributes and based on the determined log attributes, a retention criteria specifying a retention period for the log is identified. The identified retention criteria is then applied to maintain the log in a repository. In another example, a request to modify a retention period is received. A conflict between existing and proposed retention criteria is determined based on evaluation factors. If no conflict exists, the new retention period is associated with the log.

### BACKGROUND

In various industries, applications generate and maintain log files or logs that record actions or events within a processor-based system. Such actions or events may pertain to various stages, tasks performed, actions implemented, or data which may be related to either operation or development of variety of applications, products or services. The logs may be used for multiple purposes, examples of which include, but are not limited to troubleshooting, performance monitoring, security analysis, or even compliance assessment in relation to processes implemented within an organization. It may be noted that as applications and such underlying processes become complex, the volume and variety of logs continue to grow. The logs if not retained in an organized manner may result in inefficiencies while performing one or more functions for which logs may be used.

### BRIEF DESCRIPTION OF FIGURES

Systems and/or methods, in accordance with examples of the present subject matter are now described and with reference to the accompanying figures, in which:

FIG. 1 illustrates a system for managing retention of a log, as per an example;

FIG. 2 illustrates an organizational environment, implementing a log retention system for managing retention of a log, as per an example;

FIG. 3 illustrates a detailed block diagram of a log retention system for managing retention of a log, as per an example;

FIG. 4 illustrates a detailed diagram depicting application of a retention criteria to a log, as per an example;

FIG. 5 illustrates a computing environment for modifying a retention criteria associated with a log, as per an example;

FIG. 6-7 illustrates other exemplary scenarios for modifying a retention criteria associated with a log, as per an example;

FIG. 8 illustrates a computing environment for modifying a retention criteria associated with a log based on a user calendar, as per another example;

FIG. 9 illustrates a method for modifying a retention criteria associated with a log, as per an example;

FIG. 10 illustrates a method for managing retention of a log, as per an example;

FIG. 11 illustrates a detailed method for modifying a retention criteria associated with a log, as per an example;

FIG. 12 illustrates a method for modifying a retention criteria associated with a log based on a user calendar, as per an example; and

FIG. 13 illustrates a system environment implementing a non-transitory computer readable medium for modifying a retention criteria associated with a log based on a user calendar, as per an example.

### DETAILED DESCRIPTION

Logs record actions or events that may occur within a processor-based system. The logs may pertain to the functioning of a processor-based system or to the execution of one or more applications that may be executing on the processor-based system. It may be the case that an organization implements a plurality of processes for development of either a product or services, with the processes each monitored or managed by one or more applications. In such instances, the logs may act as records providing information pertaining to various stages, tasks performed, actions implemented, or data related to development of products or services, across multiple stages.

The logs may be used for, amongst other aspects, ensuring compliance and facilitating audits in the context of product or service development. In order to assess whether certain compliances were adhered to during the development of the product or service, the logs may be referred. Processing the logs may therefore provide useful insights into assessing whether applicable compliance requirements as assessed during audit procedures (or similar exercises) were met. Any assessment in the form of an audit would involve tracing the detailed events or processes that may have occurred to eventually detect such deviations. In this manner, logs may be utilized as audit trails, recording the different events that may have occurred over a period of time

Significance of log management becomes crucial in highly regulated sectors such as healthcare, pharmaceuticals, and finance, to name a few primarily owing to complexity and sensitivity of the product development processes that may be involved and also owing to prevailing regulatory requirements. Such requirements may also vary across jurisdiction, thereby further increasing the challenges that log retention entails. Retention of logs in such instances may affect data-driven decision making, manage or prevent operational insights, or generally ensure that the processes are being implemented in an efficient and transparent manner. In the example industries, stringent compliance mandates, heightened data privacy concerns, and potential legal liabilities, making comprehensive and accurate log management crucial for maintaining regulatory compliance, detecting security breaches, and ensuring data integrity, necessitate maintaining reliable audit trail for both internal and external audits. Other considerations based on which retention criteria may be prescribed include risk assessments, business needs and objectives, system capabilities, data lifecycle, archiving, backing up of data (including logs), industry specific best practices, or a combination thereof. It may be noted that examples of such considerations are only indicative and is not exhaustive. Other example considerations may also be relied for prescribing retention criteria.

Although the size of the individual log files may be manageable, collectively the volume of logs may grow over a period of time. Logs may be retained for predefined time period by way of policies or predefined rules. Depending on the policies, the logs may be retained within a repository or may be deleted or purged, if as per the policy the logs are no longer required. However, such techniques face several technical challenges. One challenge in this aspect involves inconsistent or ad-hoc retention policies across different departments which may lead to compliance issues. Generally, different departments may have to adhere to different compliance requirements and having common retention periods for log across different departments may pose non-compliance related risks. Further, scalability becomes a problem as data volumes grow, with conventional storage approaches struggling to manage increasing volumes of log. For example, fixed retention periods offer limited flexibility to adapt to changing regulatory requirements or business needs. This may result in unnecessary storage costs and inefficient storage utilization if logs were to be retained for prolonged periods. Furthermore, managing diverse log types from different applications and systems, and in various formats additionally presents difficulties in unified management of such systems. Conventional techniques of log management often require significant manual effort for log review, retention management, and compliance reporting.

Approaches for managing retention of logs are described. The retention of logs, in an example, may be used for assessing audit trails to check for compliance with one or more prescribed regulatory requirements. The log retention may be managed across multiple type of industry verticals, such as life sciences, finance, education, retail, and technology. To this end, a log retention system may be implemented for managing a retention period of the log. The approaches may be implemented for any type of logs generated by various systems, applications, or processes across different industries. The log retention system described herein may be applied to a wide range of scenarios where efficient and compliant log retention is crucial, including but not limited to financial transactions, healthcare records, manufacturing processes, cybersecurity events, and general IT operations.

In operation, when a specific event or action occurs, a log is generated. The log may include information pertaining to an operation being implemented in a computing system, an organization, or such, or may pertain to processes for development of a product or a service. The latter processes may be implemented and managed using instructions based system. The logs generated for such processes may include information related to either the operational activities, development processes, or both for either a product or a service.

Thereafter, the log is processed to determine one or more log attribute(s) of the log. In an example, the log attribute(s) provide detailed context about the operation of the application or development of the product or service, to which the log pertain to. In an example, processing of the log involves analyzing the content, metadata, or their combination to extract the log attribute(s). In one example, the log attribute(s) may specify a type of activity recorded (e.g., a manufacturing step, quality control check, or software update), the specific product or service involved, the stage of development or operation, the user or system credentials that generated the log, timestamps and the durations of events, any associated regulatory or compliance requirements, or combination thereof.

Based on the log attribute(s) determined from processing the log, an appropriate retention criterion for that specific log is identified. In an example, the retention criteria specify a time period for which the log ought to be retained within a repository, with such time period being referred to as retention period. In one example, the identification process involves analyzing the log attribute(s) and comparing the same with corresponding attribute(s) of a predefined retention criteria. The retention criteria may correspond to a number of factors or considerations, examples of which include, but are not limited to, regulatory requirements, industry standards, internal company policies, or the specific needs of the product or service lifecycle, or a combination thereof. Such retention criteria may be associated with certain attribute(s) indicating their interrelation with different types of logs. For example, if the log pertains to a critical manufacturing step of a regulated medical device, it might require a longer retention period compared to a log of routine maintenance on a non-critical system.

Once the appropriate retention criterion is identified (i.e., based on the log attribute(s)), the system may cause the retention criteria to be applied to the log. In an example, the retention criteria may specify not only a retention time period but may also specify one or more operations that may be performed on the logs. Once stored as per identified retention criteria, an automated process may be configured to track the log's age and initiate appropriate actions when the retention period as provided by the retention criteria, expires. This may include archiving or securely deleting the log.

As may be understood, retention requirements may evolve with business needs or due to regulatory shift. To accommodate such changes, a process to modify retention criteria is described, in another example. To this end, a request may be received from a user to modify a first retention period corresponding to a first retention criteria, wherein the first retention criteria may be associated with a log. If the amended retention period is determined to be different from the already applied retention period, a conflict between the first retention criteria and the second retention criteria may be determined and resolved.

In an example, the conflict between the first retention period and the second retention period may be assessed based on an evaluation factor associated with the corresponding retention criteria. Depending on the evaluation factor of the first retention criteria and the second retention criteria, the request for modifying the retention period may be processed. In an example, the evaluation factor may be a priority factor. In this example, if the priority factor of the first retention criteria (i.e., the retention criteria already applied on a log) is greater than the priority factor of the second retention criteria, any request for altering the retention time period may be discarded or denied. On the other hand, if the priority factor of the second retention criteria is greater, then the request for modifying the first retention period may be allowed with the second retention criteria being associated with the log under consideration. It may be noted that the priority factor corresponding to each retention criteria may be prescribed based on a relative impact, relevance or any other factors indicating or prescribing one or more consequences for non-compliances. For example, retention criteria corresponding to regulatory requirements may have a higher priority factor since non-compliance with such requirements may entail penal consequences. Besides the priority factor, any other factor, such as credentials of a user attempting to modify the retention period, may be utilized without deviating from the scope of the present subject matter.

The logs for which the retention criteria are managed through the above approaches may be used as audit trails. Implementing an intelligent, rule-based and configurable mechanism for applying or modifying retention criteria for logs ensure performance enhancement, consistency and visibility as to the retention of logs which may be required for audits, or other such similar assessments. Furthermore, the current approaches provide appropriate retention strategies for different types of logs as opposed to implementing a central retention criteria, which have a tendency to impact system-storage efficiencies as well.

As may be understood, the present approaches also may analyze changes in audit schedules to adjust retention periods, and dynamically manage conflicts between multiple retention criteria. These allow for more efficient storage utilization, reduced compliance risks, and improved adaptability to changing regulatory requirements. Additionally, the ability to evaluate the impact of retention period modifications on operations and development processes ensures informed decision-making. These and other aspects are further described in relation to the accompanying figures.

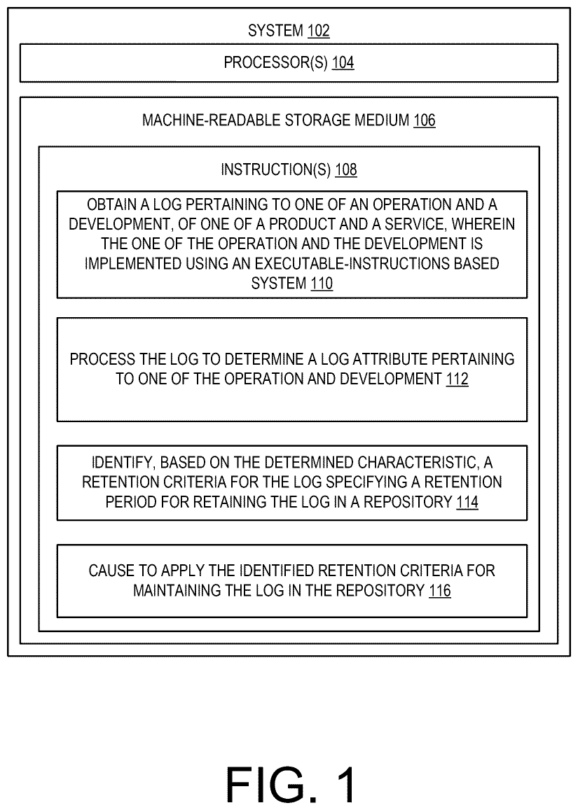

FIG. 1 illustrates a system 102 for managing retention of a log, as per an example. The system 102 includes a processor 104 and a machine-readable storage medium 106 which is coupled to, and accessible by, the processor 104. The system 102 may be implemented in any computing system, such as a storage array, server, desktop or a laptop computing device, a distributed computing system, or the like. Although not depicted, the system 102 may include other components, such as interfaces to communicate over the network with other systems or data repositories, communicate with external storage or computing devices, display, input/output interfaces, operating systems, applications, data, and other software or hardware components (all of which have not been depicted for sake of conciseness). In an example, machine-readable storage medium 106 may further include instruction(s) 108.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instruction(s) 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like.

In operation, the processor 104 may fetch and execute instruction(s) 108 for performing one or more actions, as discussed further. In an example, the execution of instructions 110 may involve the system 102 to obtain a log pertaining to one of an operation and a development, of one of a product and a service. For example, the system 102 may obtain the log from a repository or receive a log from an application monitoring the operation and development of products and services. The log is generated by an executable-instructions based system implementing or monitoring the operation or the development processes.

Continuing further, once the log is obtained, the instructions 112 may be executed to process the log to determine a log attribute(s) pertaining to the log. For example, the system 102 may analyze the content and metadata of the log to extract the log attribute(s) pertaining to the operation or development process. The log attribute(s) may include information such as the type of activity recorded, the specific product or service involved, the stage of development or operation, user or system credentials, timestamps, or associated regulatory requirements. It may be noted that, the above disclosed examples of log attribute(s) are exemplary and any other type of detail of log may be used as log attribute(s) without deviating from the scope of the present subject matter.

Thereafter, the instructions 114 may be executed to identify a retention criteria for the log specifying a retention period for retaining the log in the repository, based on the determined log attribute(s). For example, the system 102 may compare the determined log attribute(s) with corresponding attributes of a predefined retention criteria to identify the most appropriate retention period for the log. This process involves analyzing factors such as regulatory requirements, industry standards, internal company policies, or the specific needs of the product or service lifecycle.

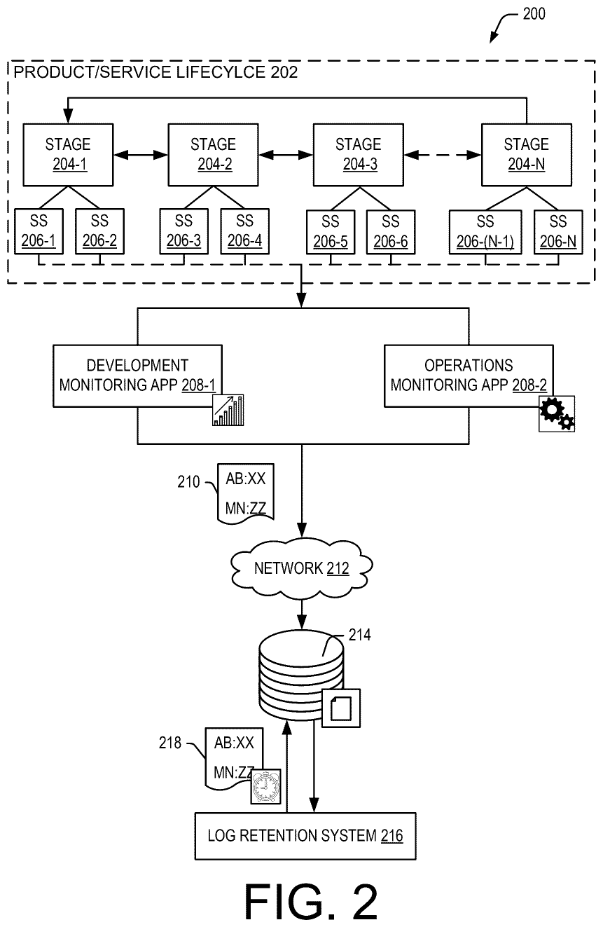

Once the retention criteria is identified, the instructions 116 may be executed to cause the application of the identified retention criteria onto the log under consideration. Once the identified retention criteria is applied, the log is maintained in the repository as per the retention criteria. For example, the system 102 may tag or associate the log with metadata indicating the retention criteria to be applied. This may include specifying not only the retention period but also any operations to be performed on the logs during or after the retention period expires. The above aspects in relation to the system 102 are further discussed in detail in relation to FIG. 2. FIG. 2 illustrates an organizational environment 200 representing various stages involved in a product/service lifecycle 202 (referred to as lifecycle 202) and various entities involved in monitoring the lifecycle 202. It may be noted that the block, lifecycle 202, are to indicate different operations that may be performed as part of the lifecycle 202.

Continuing further, the block depicting the lifecycle 202 may comprise a plurality of stage(s) 204-1, 2, . . . N (collectively referred to as stage(s) 204) which are involved in the development of the product or the service. Each of the stage(s) 204 may correspond to one or more industrial, administrative, or other processes that may be implemented within the organizational environment 200 for the development of the product and/or the service. Although the present example is explained in the context of a development process of product and/or service through various stage(s) 204, the same is not to be considered as a limitation. The stage(s) 204 may be directed towards achieving an objective or a result within an organization. Examples of such objectives includes, but are not limited to, manufacturing of products or goods, rendering of services, processing of information, for research, development in different technical fields such as life sciences, engineering, computing, and such.

The order of the different stage(s) 204 may be prescribed based on a workflow. As may be understood, the workflow may provide the sequence in which the different stage(s) 204 may be implemented. It is pertinent to note that the stage(s) 204 are depicted in a serial manner for ease of reference only. The stage(s) 204 may include a complex sequences of stages, with any or more stage either connected to multiple prior stages, or may be connected to multiple other subsequent stage(s). Such examples would also fall within the scope of the present subject matter.

The stage(s) 204 may represent separate phases of the lifecycle 202, such as conceptualization, design, development, testing, deployment, maintenance, and eventual operation of a product or a service. Each of the stage(s) 204 of the lifecycle 202 may include one or more sub-stages, with sub-stages providing a granular breakdown for each stage within the lifecycle 202. In a product development context, a stage might represent the overall design phase, while its sub-stages may include initial concept sketching, detailed engineering, prototype development, and design review. Such difference in workflows do not alter the scope of the claimed matter in any manner, and would continue to fall within the scope of the present subject matter.

In the context of the example illustrated in FIG. 2, the stage 204-1 may include sub-stage 206-1, 206-2, while stage 204-2 may include sub-stages 206-3, 206-4, stage 204-3 may include sub-stages 206-5, 206-6, and stage 204-N may include sub-stages 206-(N−1), 206-N. The various stage(s) 204 may be interlinked with each other in any manner. For example, as depicted in FIG. 2, once the stage 204-1 is completed, the process proceeds to stage 204-2 and subsequently to stage 204-3 and stage 204-N. Specifically, at granular level, once the sub-stages 206-1, 206-2 of the stage 204-1 is completed, the process proceeds to sub-stages 206-3, 206-4 of the stage 204-2. Each stage and corresponding sub-stage are result in generating a log, which may then be stored and used as an audit trail.

The organizational environment 200 further includes a development monitoring application 208-1 and an operations monitoring application 208-2. The development monitoring application 208-1 is configured to monitor aspects of the stage(s) 204 related to the creation and enhancement of the product and/or service throughout the lifecycle. For example, it may monitor stage(s) 204 pertaining to conceptualization, design, testing, and pre-release activities. On the other hand, the operations monitoring application 208-2 is configured to monitor aspects of the stage(s) 204 related to the functioning and performance of the product or service throughout the lifecycle. For example, it may monitor stages related to live operations, user interactions, system performance, and maintenance activities.

Although depicted as separate applications, the development monitoring application 208-1 and the operations monitoring application 208-2 may be implemented as a single application. Collectively, the development monitoring application 208-1 and the operations monitoring application 208-2 are referred to as monitoring application(s) 208. The monitoring application(s) 208 may be in communication with one or more sensor(s) (not depicted in FIG. 2) deployed within the organizational environment 200. The monitoring application(s) 208 may, based on the data gathered and obtained from such sensor(s), may determine the state of the different stage(s) 204 within the organization.

Based on the monitored aspects of the stage(s) 204, monitoring application(s) 208 generates log(s) 210 pertaining to operations and development of product and/or the service. Once generated, the log(s) 210 may be transmitted to a repository 214 through a network 212 for storage. The network 212 may be a private network or a public network and may be implemented as a wired network, a wireless network, or a combination of a wired and wireless network. The network 212 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

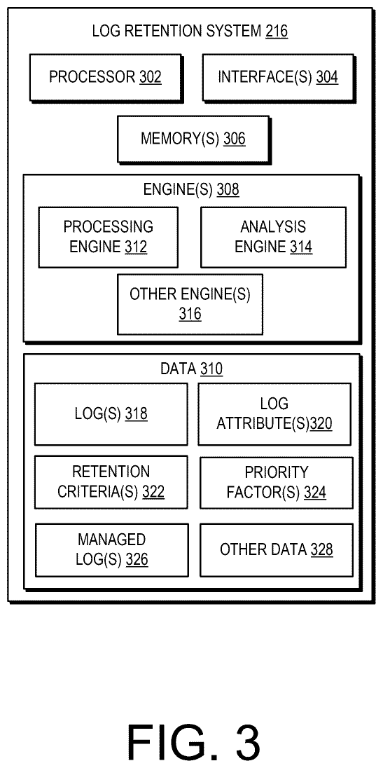

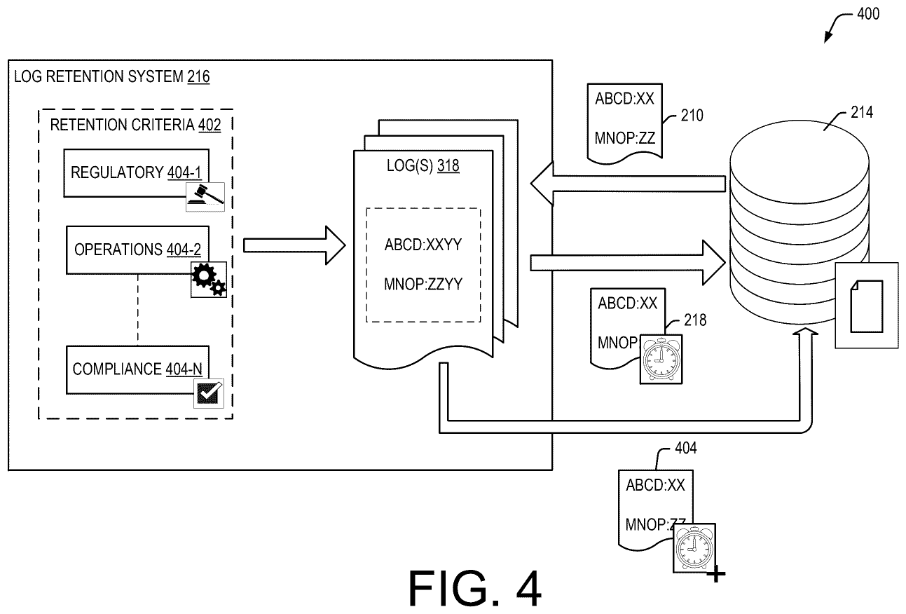

The organizational environment 200 may further include a log retention system 216 which is in communication with the repository 214. The log retention system 216 (referred to as system 216) may determine a retention criteria specifying a retention period to be applied to the logs stored in the repository 214. As would be discussed in further detail, the retention criteria is determined based on one or more log attribute(s). Once determined, the retention criteria may be applied based on which the retention of the logs may be managed. In an example, the retention of logs may be performed in an efficient manner (as opposed to a relying on a single retention criteria) ensuring that the same may be appropriately available for audit or related purposes. Once applied, the log may be maintained as a retention managed log(s) 218 or a managed log(s) 218. These aspects are explained in conjunction with FIGS. 3-4.

FIG. 3 depicts various functional blocks of the system 216, as per an example. The system 216 includes a processor 302, interface(s) 304, and memory(s) 306. The processor 302 may be implemented as microprocessors, microcomputers, microcontrollers, digital signal processors, central processing units, state machines, logic circuitries, and/or other devices that manipulate signals based on operational instructions. The interface(s) 304 may allow the connection or coupling of the system 216 with one or more other devices, through a wired (e.g., Local Area Network, i.e., LAN) connection or through a wireless connection (e.g., Bluetooth®, Wi-Fi). The interface(s) 304 may also enable intercommunication between different logical as well as hardware components of the system 216. The interface(s) 304 may also enable the system 216 to communicate with other entities, such as the repository 214, client computing device (as depicted in subsequent figures), or other devices or systems.

The memory(s) 306 may be a computer-readable medium, examples of which include volatile memory (e.g., RAM), and/or non-volatile memory (e.g., Erasable Programmable read-only memory, i.e., EPROM, flash memory, etc.). The memory(s) 306 may be an external memory, or internal memory, such as a flash drive, a compact disk drive, an external hard disk drive, or the like. The memory(s) 306 may further include data which either may be utilized or generated during the operation of the system 216.

The system 216 may further include engine(s) 308 and data 310. The engine(s) 308 may be implemented as a combination of hardware and programming, for example, programmable instructions to implement a variety of functionalities of the engine(s) 308. In examples described herein, such combinations of hardware and programming may be implemented in several separate ways. For example, the programming for the engine(s) 308 may be executable instructions. Such instructions may be stored on a non-transitory machine-readable storage medium which may be coupled either directly with the system 216 or indirectly (for example, through networked means). In an example, the engine(s) 308 may include a processing resource, for example, either a single processor or a combination of multiple processors, to execute such instructions. In the present examples, the non-transitory machine-readable storage medium may store instructions that, when executed by the processing resource, implement engine(s) 308. In other examples, the engine(s) 308 may be implemented as electronic circuitry.

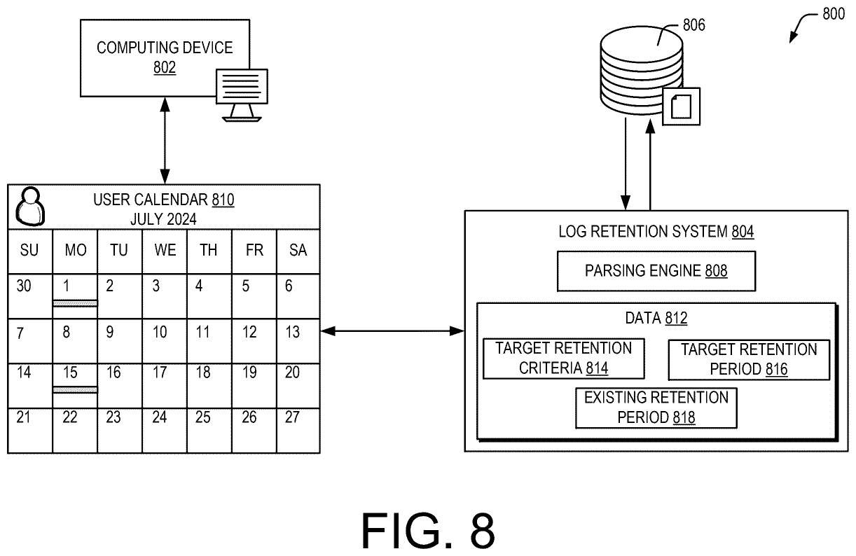

The engine(s) 308 includes a processing engine 312, an analysis engine 314, and other engine(s) 316. The other engine(s) 316 may further implement functionalities that supplement functions performed by the system 216 or any of the engine(s) 308. In an example, the engine(s) 308 may also include a parsing engine (shown in FIG. 8) for parsing a user calendar to detect changes related to audit events within the user calendar. It may be noted that the functions of the parsing engine may also be performed by the system 216 itself without requiring any dedicated engine.

The data 310, on the other hand, includes data that is either stored or generated as a result of functions implemented by any of the engine(s) 308 or the system 216. It may be further noted that information stored and available in data 310 may be utilized by the engine(s) 308 for performing various functions to be implemented by the system 216. In an example, data 310 may include log(s) 318, log attribute(s) 320, retention criteria(s) 322, priority factor(s) 324, managed log(s) 326, and other data 328. It may be noted that such examples of the various functional blocks as depicted in FIG. 3 are indicative. The present approaches may be applicable to other examples without deviating from the scope of the present subject matter.

The working of the system 216 (via functional blocks as depicted in FIG. 3) is explained in conjunction with various elements of the organizational environment 200 (as described in FIG. 2). In operation, during any development process of a product or a service, sensors deployed within each stage of lifecycle 202 may generate specific data related to its activities and outcomes. In an example, this data generation occurs continuously throughout the lifecycle 202 stages, i.e., from stage 204-1 through to stage 204-N. Throughout these stage(s) 204, the monitoring application(s) 208 actively monitors and records this data generation. In an example, these applications may integrate with various tools and systems (not shown in FIG. 3) used in each stage to collect such data in real-time. The sensors may be deployed throughout the stage(s) 204 may capture real-time data on system parameters, environmental conditions, equipment performance, and other relevant parameters, or equipment, systems and such. These sensors may provide continuous streams of data which may be incorporated into the logs, enhancing the depth and accuracy of monitoring process.

Once recorded, the monitoring application(s) 208 process the data, converting raw information into structured logs. Each log may include details, but are not limited to, timestamp, event type, associated user or system, and relevant metadata. Examples of logs include, but are not limited to, a batch production record, equipment usage and maintenance logs, quality control text results, product release approvals, corrective and preventive action (CAPA) events, supplier qualification assessment, regulatory submission tracking, adverse events reports, product complaint handling, electronic signature records, formulation change records, clinical trial data entries, stability testing results, method validation documentation, technology transfer activities, design control milestones, risk assessment updates, software validation records, and user equipment specifications.

The logs may then be transmitted via the network 212 to the repository 214 for storage. In an example, the transmission of logs may occur in real-time or in batches, depending on the system configuration and nature of the data. Once stored in the repository 214, the logs become available for further processing by the system 216.

The processing engine 312 of the system 216 then obtains logs stored in the repository 214 and stored them as log(s) 318 in the system 216 for further processing, or specifically applying retention criteria to the log(s) 318. Once obtained, the processing engine 312 processes the log(s) 318 to determine log attribute(s) 320 of the log(s) 318. In an example, the log(s) 318 is processed to extract and analyze its content and metadata, determining specific log attributes(s) 320 that provide insight into the log's nature and context. In one example, the log attribute(s) 320 pertain to either the operation or development aspects of the product and/or service. For instance, an attribute may reveal the type of activity recorded (e.g., a manufacturing step, quality control check, or software update), the specific product or service involved, the stage of development or operation, the user or system credentials that generated the log(s) 318, timestamps and other features of the log(s) 318.

Based on the determined log attribute(s) 320, the system 216 then identify one or more retention criteria for the log(s) 318. In an example, the system 216 determines retention criteria(s) 322 for the log(s) 318. In an example, the retention criteria(s) 322 identified for the log(s) 318 corresponds to a retention factor, which specifies a category of requirements that determine the retention period for the log(s) 318. These retention factors may include various conditions such as regional or location parameters, regulatory frameworks, industry practices, performance metrics, business needs, storing capabilities, data privacy related conditions, risk related factors, or a combination thereof.

In an example, the identification of retention criteria(s) 322 involves analyzing the determined log attribute(s) 320 of the log(s) 318 and comparing them with corresponding attributes associated with predefined retention criteria stored in the repository 214. For example, the processing engine 312 compares a target value corresponding to the log attribute(s) 320 of the log(s) 318 with a corresponding tagged value of the attribute(s) which are previously associated with each retention criteria in the repository 214. Based on the comparison, the processing engine 312 identifies one or more relevant retention criteria for storing the log(s) 318 in the repository 214.

For example, consider a log generated during a pharmaceutical product development process with attributes such as “Log Type: Clinical Trial Data, Product: Drug X, and Development Stage: Phase III Trial”. The processing engine 312 may compare these attributes against retention criteria stored in the repository 214, such as Criteria 1 (Clinical Trial Data, 15 years retention, FDA), Criteria 2 (Manufacturing process, 5 years retention, Good Manufacturing Practices (GMP)), and Criteria 3 (Clinical Trial Data, 25 years retention, EMA). The processing engine 312 may compare the attribute “Clinical Trial Data” with tags of each retention criteria. As a result of comparison, it may then identify Criteria 1 and 3 as potential matches due to the matching “Clinial Trial Data” tag. It may be noted that the log attribute(s) depicted above by way of example are only indicative. The log attribute(s) may be depicted through other descriptive text, encoded sequence of characters, or combination thereof, without deviating from the scope of the present subject matter.

In case of multiple retention criteria identified as relevant for the log(s) 318, the processing engine 312 determines priority factor(s) 324 corresponding to each retention criteria which are identified as relevant for storing the log(s) 318. In an example, the priority factor(s) 324 corresponding to each retention criteria may be prescribed based on a relative impact, relevance or any other factors indicating or prescribing one or more consequences for non-compliances.

In another example, the system 216 may employ a machine learning model to determine retention criteria(s) 322 for log(s) 318 based on their log attribute(s) 320. The machine learning model may be trained using a training dataset comprising log attributes and their corresponding retention criteria. Once trained, the machine learning model may correlate one or more log attributes of an input log, such as log(s) 210, and determine an appropriate retention criteria, such as retention criteria(s) 322. In an example, the log attributes of the input log are applied to the trained machine learning model to output the retention criteria(s) 322 to be applied to the input log. The training dataset may include a wide variety of log attributes such as log type, content, source, timestamp, associated product or service, development stage, operational context, and regulatory requirements. In an example, each of the set of attributes in the training dataset is paired with a corresponding retention criteria. The trained machine learning model may not only provide the retention criteria(s) 322 to be applied but, in one example, may also indicate other considerations for retaining the logs, such as the log(s) 210. Such consideration include, but are not limited to, storage location, access controls, or archival requirements.

Returning to the present example, once the retention criteria(s) 322 is identified, the processing engine 312 applies the identified retention criteria(s) 322 to the log(s). Such application of retention criteria(s) 322 may involve several actions. For example, the processing engine 312 may tag or associate the log(s) 318 with metadata indicating the specific retention criteria(s) 322 to be applied to obtain managed log(s) 326. In an example, the retention criteria(s) 322 may be applied based on the evaluation factor, such as a priority factor associated therewith. For example, retention criteria having highest priority factor may be applied to the log(s) 318, to provide managed log(s) 326.

Once applied, the system 216 may then store the managed log(s) 326 in a designated location within the repository 214 that corresponds to its retention criteria requirements. For example, the system 216 transmits the managed log(s) 326 (or managed log(s) 218 as depicted in FIG. 2) to the repository 214 for storage. In another example, as part of application of retention criteria(s) 322, the processing engine 312 may implement access controls based on the retention criteria, ensuring that only authorized personnel may view or modify the managed log(s) 326 during its retention period. The detailed depiction of application of retention criteria(s) 322 on log(s) 318 is illustrated in FIG. 4.

FIG. 4 illustrates a detailed diagram of a log retention system, such as system 216, depicting application of retention criteria to a log, as per one example. The system 216 include a block 402 named retention criteria(s) including plurality of retention criteria corresponding to various factors. For example, the retention criteria(s) 402 may include a regulatory criteria 404-1, which may be based on legal or industry-specific requirements, operations criteria 404-2, which may relate to internal business needs or operational considerations, a compliance criteria 404-N, which may address specific compliance standards or protocols, and many more criteria. It may be noted that above disclosed examples of retention criteria are exemplary and retention criteria(s) 402 may include any type of retention criteria without deviating from the scope of the present subject matter.

The system 216 is capable of operating in multiple scenarios to manage retention of log effectively. In one scenario, input logs, such as log(s) 210, are obtained from the repository 214. For example, as described above as well, the processing engine 312 of the system 216 obtain log(s) 210 from the repository 214 and store them as log(s) 318 to subsequently process them to determine relevant retention criteria from the available options in the retention criteria(s) 402. Once stored, the processing engine 312 process and analyze these log(s) 210 to determine the relevant retention criteria from the available options in the retention criteria(s) 402. In some examples, the system 216 may identify more than one retention criteria as well for associating with the log(s) 318.

Once the relevant retention criteria is determined, the system 216 applies the relevant retention criteria to log(s) 318 and generates the managed log(s) 218 (or managed log(s) 326). In an example, the manged log(s) 218 includes metadata specifying the applicable retention period and any other relevant retention parameters. The system 216 then transmits this managed log(s) 218 back to the repository 214 for storage as per the applied retention criteria. The repository 214 in turn stores the managed log(s) 218 according to the specified retention criteria, ensuring it is kept for the appropriate duration and managed correctly throughout its lifecycle.

In another scenario, the system 216 handles logs, such as managed log(s) 326 that are already associated or tagged with retention criteria(s) 402 but require modifications. In an example, this situation may arise due to changes in regulations, business policies, or other factors affecting retention requirements. Due to such changes in retention requirements, specific retention criteria is to be amended to indicate the updated retention period so that the log(s) 318 will be managed for appropriate period of time. In this case, the input log(s) 210 received from the repository 214 already have retention criteria applied, but this applied retention criteria(s) 402 may no longer be appropriate or optimal due to modifications in retention requirements.

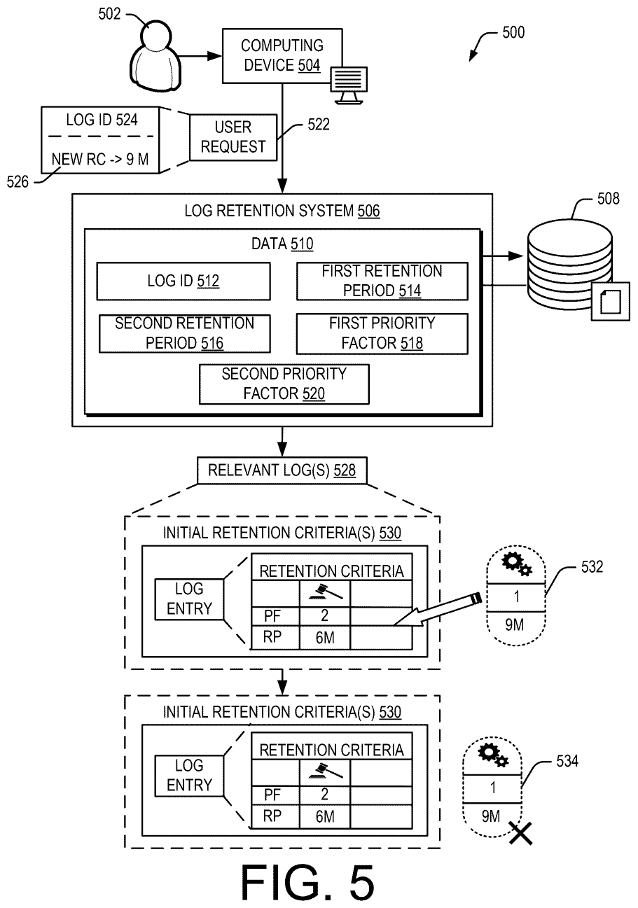

In such cases, the system 216 processes and analyzes these previously managed log(s) 326, taking into account any changes in retention policies or requirements. Based on the analysis, the system 216 may modify the existing retention criteria or apply an entirely different retention criteria to the log(s) 318 in compliance with modified requirements. The result of this process is a log with updated or modified retention criteria, such as updated managed log 406. This updated managed log 406 includes updated metadata tagged or associated with it reflecting the new or modified retention criteria. The system 216 then transmits this updated managed log 406 back to the repository 214, where it replaces or updates the previous version of the log. The scenarios illustrating modification of retention criteria is further explained in detail in conjunction with FIGS. 5-8.

FIG. 5 illustrates a computing environment 500 for modifying a retention criteria which is associated with a log, as per an example. The computing environment 500 (referred to as environment 500) includes a user 502 interacting with a computing device 504. Examples of computing device 504 includes, but are not limited to, desktop computer, laptop, tablet, smartphone, specialized workstation, or many more. The user 502 operating on the computing device 504 is one of a compliance officers, quality assurance managers, regulatory affairs specialists, IT administrators, or data governance officers. It may also encompass auditors, legal counsel, project managers, or department heads responsible for overseeing and modifying log retention criteria within their respective domains. The environment 500 further includes a log retention system 506, similar to system 216, connected over a network (not shown in FIG. 5) with the computing device 504 and a repository 508, similar to repository 214, connected to the log retention system 506. The log retention system 506 (referred to as system 506) further includes data 510, similar to data 310. The data 510 includes log ID 512, first retention period 514, second retention period 516, first priority factor 518, and second priority factor 520.

In operation, when a user, such as user 502, wishes to modify the retention criteria of a log, a user request 522 is initiated by the user 502 through the computing device 504 to be transmitted to the system 506 to modify a retention criteria of a log. In an example, the user request 522 includes a log ID 524 to identify specific log or group of logs from the repository 508 whose retention criteria is being requested for modification, and a updated retention field 526 indicating a second retention period corresponding to a second retention criteria. The log ID 524 and updated retention field 526 mentioned in user request 522 are stored in the system 506 in data 510 as log ID 512 and second retention period 516.

Upon receiving the user request 522, the system 506 analyzes it to identify a relevant log(s) 528 from the repository 508 that corresponds to the log ID 512. In an example, the system 506 may query the repository 508 to retrieve logs associated with the specified log ID 512, which may be a single log or multiple logs depending on the log ID 512. In an example, along with the relevant log(s) 528, the system 506 also retrieves an initial retention criteria(s) 530 in compliance to which the relevant log(s) 528 are currently stored in the repository 508. As depicted in FIG. 5, the initial retention criteria(s) 530 includes a first retention criteria related to regulatory framework (RC₁) having a first retention period of 6 months. This first retention period of 6 months is stored in data 510 as first retention period 514. As per the user request 522, the user has requested to change the first retention criteria to a new retention criteria, i.e., the second retention criteria 532 having the second retention period 516 of 9 months.

Once the initial retention criteria(s) 530 is retrieved, the system 506 compares the first retention period 514 with the second retention period 516. If in case, the first retention period 514 is similar to the second retention period 516, the system 506 maintains the existing retention criteria, i.e., the initial retention criteria(s) 530 for the relevant log(s) 528 without implementing the requested change. On the other hand, when the first retention period 514 is different from the second retention period 516, the system 506 determines that a conflict may arise between the first retention criteria and the second retention criteria on changing the retention period of the relevant log(s) 528. For example, as depicted in FIG. 5, the first retention period 514 corresponding to the first retention criteria (which is already associated with the relevant log(s) 528) is 6 months and the second retention period 516 corresponding to the second retention period is 9 months. To this end, the system 506 determines that conflict between the first retention criteria and the second retention criteria may be present.

To further confirm the conflict, the system 506 performs an assessment between the first retention criteria and the second retention criteria based on an evaluation factor. The evaluation factor may be a quantitative or qualitative measure used to assess and compare different retention criteria. In some aspects, the evaluation factor may be a composite factor derived from multiple factors, providing a comprehensive basis for determining conflicts between the retention criteria. Examples of evaluation factor may include a priority factor associated with corresponding retention priority factor, a user credential of the user who has initiated the request to change the retention criteria, and impact on system capability. Examples of evaluation factor described above are exemplary and any other factor which helps in comparing the retention criteria may be used without deviating from the scope of the present subject matter. To this end, when it is determined that the no conflict is present between the first retention criteria and the second retention criteria, the system 506 proceeds to associate the second retention criteria with the relevant log(s) 528 having second retention period and/or other functions or operations which may be performed on the relevant log(s) 528.

In FIG. 5, the determination of conflict is performed based on the priority factor of the corresponding retention criteria, however, any other evaluation factor may be used without deviating from the subject matter. To determine conflict between the first retention criteria and the second retention criteria, the system 506 determines the first priority factor 518 corresponding to the first retention criteria and the second priority factor 520 corresponding to the second retention criteria. In an example, the first priority factor 518 and the second priority factor 520 are determined based on the relative impact, or relevance, or any other factors indicating or prescribing one or more consequences for non-compliances.

Once the priority factors are determined, the system 506 compares the first priority factor 518 with the second priority factor 520. This comparison is performed to check whether the requested change is permissible or not. Based on the comparison, when it is determined that the first priority factor 518 is higher than the second priority factor 520, the system 506 denies the request to change the existing retention criteria, i.e., first retention criteria. For example, as depicted in FIG. 5, since the first priority factor 518, i.e., ‘2’ is higher than the second priority factor 520, i.e., ‘1’, the initial retention criteria(s) 530 remain unchanged and the second retention criteria 532 is denied as depicted by reference numeral 534. Such denial of request may be based on factors such as ensuring compliance with higher-priority regulatory requirements, preserving critical operational information, maintaining data integrity, or safeguarding against potential legal risks associated with premature data deletion. Above disclosed factors are exemplary, and the denial may be based on any other factors without deviating from the present subject matter.

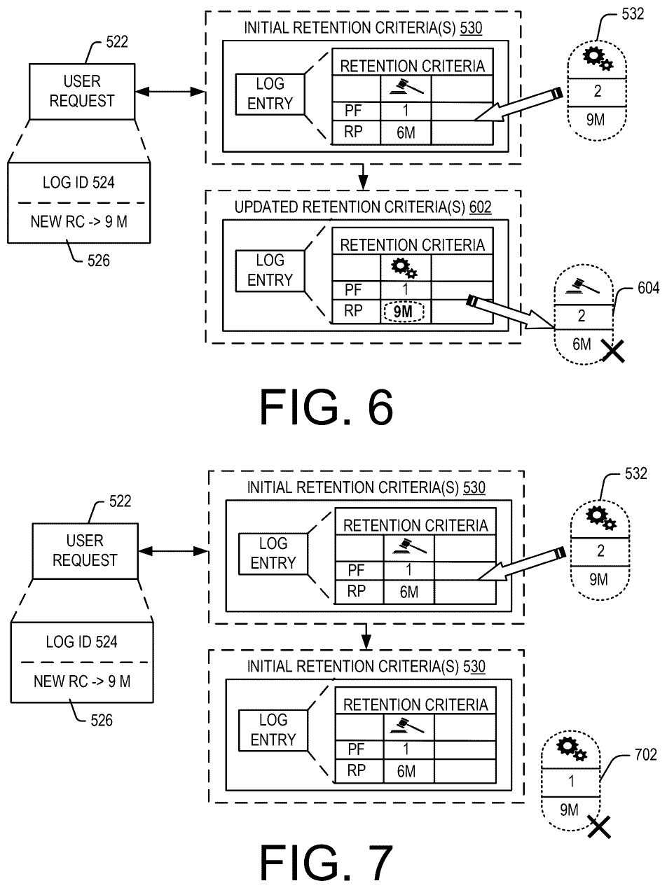

On the other hand, when it is determined that the first priority factor 518 is less than the second priority factor 520, the system 506 proceeds to replace the first retention criteria by associating the second retention criteria with the relevant log(s) 528. For example, as depicted in FIG. 6, since the first priority factor 518, i.e., ‘1’ is lower than the second priority factor 520, i.e., ‘2’, the initial retention criteria(s) 530 is updated to updated retention criteria(s) 602 with second retention criteria 532 being associated with the relevant log(s) 528 and the first retention criteria is discarded or disassociated from the relevant log(s) 528 (as depicted by reference numeral 604).

In another example, even if it is determined that the first priority factor 518 is less than the second priority factor 520, the system 506 may still deny the request to update the retention criteria depending on the value of second retention period, i.e., whether it is greater than the first retention period or less than the first retention period. For example, in one example, if the second retention period 516 is greater than the first retention period, then the denial may be due to reasons such as, preventing excessive data storage costs, maintaining system performance by avoiding unnecessary data retention, aligning with data minimization principles for privacy compliance, and optimizing storage resource allocation. In another example, if the second retention period 516 is less than the first retention period, then the denial by the system 506 may be due to reasons such as preserving critical historical logs, maintaining compliance with minimum retention requirements, safeguarding against premature data loss for audit, and ensuring availability of data for long-term analysis.

In such cases, the system 506 evaluates an impact of the requested changes on the operation and development of one of the products and the service. It may be noted that the impacts of such change in retention period may include effects on data storage capacity, system performance, information security, and resource allocation. However, in the present example, cost is considered as one of the significant factors when evaluating the impact of modifying retention periods. Continuing further, based on the evaluation of impact of requested changes, the system 506 facilitates rendering of a cost impact on the computing device 504 to the user 502. In an example, the cost impact may be rendered on a display device of the computing device 504. The cost impact indicates impact of the requested changes on the operation and development of one of the product and service. Once rendered, the system 506 receives confirmation from the user 502 through a user interface to proceed with the requested change. This means that, based on the cost impact rendered on the computing device 504, the user may take a call whether requested changes should be performed or not.

Once the confirmation is received, the system 506 initiates the process to alter the first retention period to the second retention period. However, on the other hand, in case of disagreement from the user, the system 506 does not alter the first retention period to the updated retention period (as depicted in FIG. 7 with reference numeral 702) and deny the user request.

Continuing further, once a retention period is modified, it is crucial to evaluate the corresponding relevant log(s) to determine whether it should be deleted or retained based on the updated retention period. To do so, with every change in retention criteria, the system 506 determines a current age of the relevant log(s) 528. In an example, the system 506 utilizes a timestamp indicating the origination date and time of the relevant log(s) 528. The system 506 then compares the current age of the relevant log(s) 528 with the second retention period 516 corresponding to the second retention criteria. Based on the comparison, if it is determined that the current age of the relevant log(s) 528 exceeds the second retention period 516, the system 506 proceeds to delete the relevant log(s) 528 from the repository 508.

For example, if a log was created 18 months ago and its retention period is updated from 24 months to 12 months, the system 506 would determine that the log's current age has exceeded the new retention period and consequently proceeds to delete the log from the repository. On the other hand, if the retention period is extended, the log which might be scheduled for deletion under the old retention criteria would be retained under the updated retention criteria.

FIG. 8 illustrates an exemplary computing environment 800 (similar to environment 500) for modifying a retention criteria associated with a log based on changes detected in a user calendar, as per another example. The computing environment 800 (referred to as environment 800) includes a computing device 802 connected through a network (not shown in FIG. 8) to a log retention system 804, similar to system 216, or system 506. In an example, the computing device 802 is capable of retrieving logs from a repository 806 through the log retention system 804 which are relevant for particular audit events. The repository 806 is connected to the log retention system 804 (referred to as system 804). The log retention system further includes a parsing engine 808 which is configured to parse a user calendar 810 received from the computing device 802. In an example, the user calendar 810 is a calendar specifying future or upcoming audit events, such as financial audits, compliance audit, operational audits, quality audits, etc. The system 804 further includes a data 812 including a target retention criteria 814, a target retention period 816, and an existing retention period 818.

In an example, the user calendar 810 depicts a graphical interface that displays days, weeks, or months in a grid format. It may allow users to create, view, and manage events, appointments, and deadlines related to various aspects of product or service development, operations, and compliance activities. Users may have the ability to set reminders, schedule recurring events, and share calendars with other team members or departments. The calendar may also integrate with other systems, such as system 804, automatically updating retention periods for relevant logs based on changes in scheduled audit events or compliance deadlines.

As would be known, audit events may be used for ensuring compliance throughout lifecycle 202, of a product and/or a service. These audit events are typically performed at critical stages of development or operation, and may include regulatory inspections, quality assurance reviews, or internal compliance checks. During these processes, auditors rely on logs that have been recorded throughout the product or service lifecycle in a prescribed order and manner. These logs serve as audit trials, capturing detailed information about various processes, decisions, and actions taken during development and operations.

In industries, such as pharmaceuticals, medical devices, or aerospace, prescribed audit procedures are typically established for different stages of development or operation. These procedures may include design review checkpoints, risk assessment documentation, validation of manufacturing processes, quality control sampling and testing. In one example, if these prescribed procedures are followed correctly, the logs capture the details of each steps, including timestamps, responsible personnel, and outcomes. For instance, a log entry might record “Design review for component X completed on 2023 Jun. 15, approved by person A, all safety criteria met”. This level of details allows the auditor to verify that proper procedures were followed and that all necessary steps were taken to ensure quality and safety.

Conversely, if procedures are not followed correctly, the logs capture this information as well, providing a clear record of deviations or issues. For example, a log might state: “Quality control test for Batch Y failed on 2023 Jul. 1, deviation from standard procedure noted. Corrective action initiated by person B” This transparency in logging both compliant and non-compliant actions is crucial for identifying areas for improvement and demonstrating a commitment to quality and regulatory compliance.

To conduct such audit events as per a timeline, the logs or the audit trails relevant for a particular audit event is required to be retained for a required retention period. However, such retention period may be required to be adjusted based on the changes in the audit schedules. In one scenario, whenever a timeline for a future audit event changes, the retention period for logs or audit trails which are required for the future audit event must be updated. These changes in audit timelines may occur due to various reasons, such as regulatory body scheduling changes, internal resource allocation adjustments, or in response to significant events or findings that necessitate an earlier or later audit.

If an inspection is rescheduled to a later date, the retention period for relevant logs may need to be extended to ensure their availability during the future audit. Conversely, if an internal audit is moved to an earlier date, the system may need to ensure that all relevant logs are immediately accessible and not at risk of deletion under previous retention policies.

In one implementation, these changes in audit event timelines are detected via a user calendar, such as user calendar 810. A log retention system, such as system 804 continuously monitors the user calendar 810 to detect any modifications to scheduled audit events or processes. When a change is detected, the system 804 automatically identifies the logs relevant to the rescheduled audit and adjusts their retention periods accordingly.

In operation, the system 804 continuously monitors the user calendar 810 for detecting changes with respect to audit events or processes. In an example, a user, e.g., an auditor, operating on the computing device 802 keeps a track on all audit events via the user calendar 810. Once the changes are detected within the user calendar 810, the parsing engine 808 of the system 804 parses the user calendar 810 to identify the type of changes. Examples of changes in the user calendar 810 includes, but are not limited to, scheduling of a new audit process, a modification of an existing audit event, and cancellation of a scheduled audit event.

Based on the detected changes, the parsing engine 808 identifies a relevant log pertaining to a changed audit event by analyzing the nature and timing of the audit event along with the content and metadata of stored logs. For example, if a regulatory compliance audit for a medical device is rescheduled, the parsing engine 808 may search for logs containing specific keywords or tags related to that device's manufacturing process, quality control tests, regulatory submissions, etc. In another example, the parsing engine 808 may use predefined rules or machine learning algorithms to assess log relevance, considering factors such as log's origin, quality assurance department), associated product codes, or regulatory identifiers.

Once identified, the parsing engine 808 extracts the target retention criteria 814 relevant to the identified log. In an example, based on the identified log, the parsing engine 808 extracts the target retention criteria 814 from the repository 806 which is associated with the identified log. In one example, the repository 806 includes a look up table mapping log(s) with corresponding retention criteria associated with them. While changing or updating the existing retention criteria of identified log based on the changes detected in the user calendar 810, a conflict may arise. In such cases, as described in conjunction with FIG. 5, the system 804 or system 506 performs a conflict determination to ensure that changing the retention period does not create conflicts. This conflict check may be based on various evaluation factors, such as priority factors assigned to each retention criteria, user credential of the user, and system capabilities.

If there are no conflicts, the parsing engine 808 analyzes the changes detected in the user calendar 810 to determine the target retention period 816 for the extracted target retention criteria 814. For example, when a change is detected in the user calendar 810, such as rescheduling a Food and Drug Administration (FDA) inspection from September (9th month) to December (12th Month), the parsing engine 808 determines the target retention period 816 as 12 months.

Once determined, the parsing engine 808 compares the target retention period 816 with the existing retention period 818 of the target retention criteria 814. In an example, the existing retention period 818 is a retention period for which the logs are currently being retained in the repository 806. Based on the comparison, when it is determined that the target retention period 816 is greater than or equal to the existing retention period 818, the parsing engine 808 initiates the process to alter the existing retention period 818 by lengthening it to the target retention period 816. On the other hand, when it is determined that the target retention period 816 is less than the existing retention period 818, the parsing engine 808 initiates the process to alter the existing retention period 818 by shortening it to the target retention period 816.

In an example, a pharmaceutical company maintains logs of its drug manufacturing processes and specified existing retention criteria as 5 years. In case, the system 804 detects a change in the user calendar that a regulatory audit which was scheduled for June 2024 has been moved to December 2024. The system 804 analyzes this change and determines that the relevant logs now need to be retained for 5.5 years to cover the new audit date. Since the target retention period 816 exceeds the existing retention period 818, the system lengthens the existing retention period to 5.5 years for the relevant logs.

On the other hand, if the audit had been moved earlier, e.g., to March 2024, resulting in a target retention period of 4.75 years, the system 804 would shorten the existing retention period from 5 years to 4.75 years.

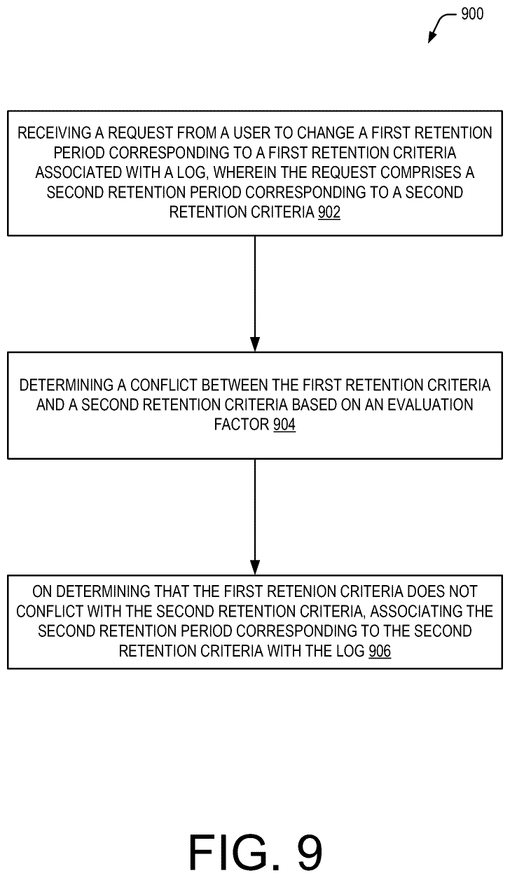

FIG. 9 illustrates a method for modifying a retention criteria associated with a log, as per an example. The order in which the above-mentioned method is described is not intended to be construed as a limitation, and some of the described method blocks may be combined in a different order to implement the method, or an alternative method.

Furthermore, the above-mentioned method may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a log retention system, such as system 216, or system 506, or system 804. In an implementation, the method may be performed under an “as a service” delivery model, where the system 216 or system 506 or system 804, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 900 may be implemented by the system 506 (or system 216) for modifying a retention criteria of a log, wherein the log is managed in the repository as per the retention criteria. The present method 900 is explained from the perspective of a first retention criteria and a second retention criteria, wherein the first retention criteria is associated with a log and the second retention criteria is proposed to be associated with the log. Although the present explanation is provided in relation to the first retention criteria and the second retention criteria, these approaches may also be applicable for a greater number of retention criteria. Such implementations too would fall within the scope of the present subject matter.

At block 902, a request from a user to change a first retention period corresponding to a first retention criteria may be received. In an example, the first retention criteria is associated with a log for managing storage of the log in the repository. For example, when a user, such as user 502, wishes to modify the retention criteria of a log, the user request 522 is initiated by the user 502 through the computing device 504 to be transmitted to the system 506 to modify a retention criteria of a log. In an example, the user request 522 includes the log ID 524 to identify specific log or group of logs from the repository 508 whose retention criteria is being requested for modification, and the updated retention field 526 indicating the second retention period corresponding to the second retention criteria. The log ID 524 and updated retention field 526 mentioned in user request 522 are stored in the system 506 in data 510 as log ID 512 and second retention period 516.

At block 904, a conflict between the first retention criteria and a second retention criteria is determined. In an example, the conflict between the first retention criteria and the second retention criteria indicates that changing first retention criteria may not be permissible based on certain evaluation factors. For example, the system 506 performs an assessment between the first retention criteria and the second retention criteria based on an evaluation factor. The evaluation factor may be a quantitative or qualitative measure used to assess and compare different retention criteria. In some aspects, the evaluation factor may be a composite factor derived from multiple factors, providing a comprehensive basis for determining conflicts between the retention criteria. The evaluation factor is one of a priority factor associated with corresponding retention priority factor, a user credential of the user who has initiated the request to change the retention criteria, and impact on system capability.

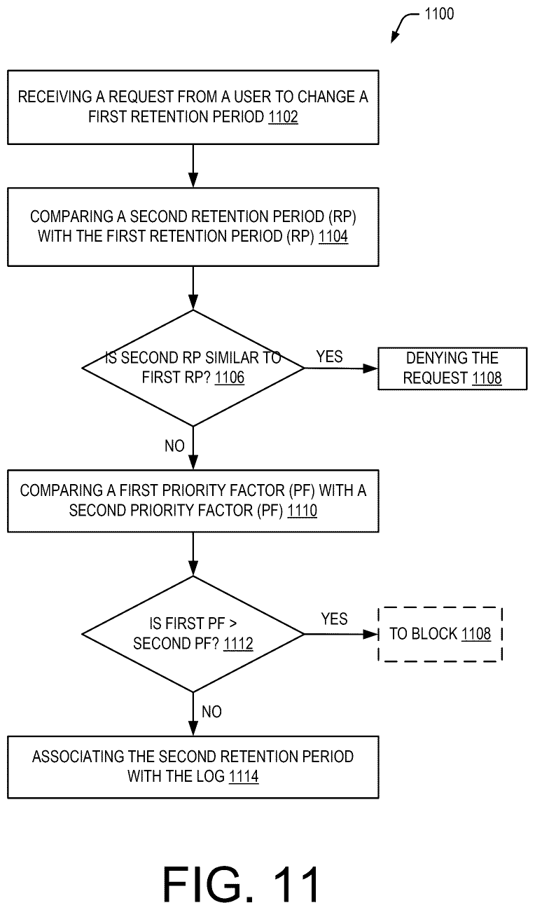

At block 906, associating the second retention period corresponding to the second retention criteria with the log. For example, when it is determined that the no conflict is present between the first retention criteria and the second retention criteria, the system 506 proceeds to associate the second retention criteria with the relevant log(s) 528 having second retention period and/or other operations which may be performed on the relevant log(s) 528. This method is described in detail in conjunction with FIG. 11.

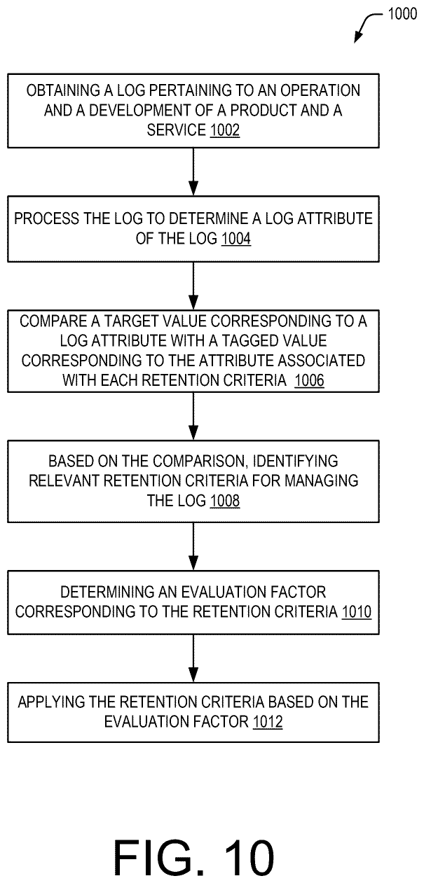

FIG. 10 illustrates a method 1000 for managing retention of a log, as per an example. The order in which the above-mentioned method is described is not intended to be construed as a limitation, and some of the described method blocks may be combined in a different order to implement the method, or an alternative method.

Furthermore, the above-mentioned method 1000 may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a log retention system, such as system 216, or system 506, or system 804. In an implementation, the method may be performed under an “as a service” delivery model, where the system 216 or system 506 or system 804, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 1002, a log pertaining to one of an operation and a development, of one of a product and a service is obtained. For example, the processing engine 312 of the system 216 obtains logs stored in the repository 214 and stored them as log(s) 318 in the system 216 for further processing, or specifically applying retention criteria to the log(s) 318.

At block 1004, the log is processed to determine a log attribute of the log. For example, the processing engine 312 processes the log(s) 318 to determine log attribute(s) 320 of the log(s) 318. In an example, the log(s) 318 is processed to extract and analyze its content and metadata, determining specific log attributes(s) 320 that provide insight into the log's nature and context. In one example, the log attribute(s) 320 pertain to either the operation or development aspects of the product and/or service. For instance, a log attribute may reveal the type of activity recorded (e.g., a manufacturing step, quality control check, or software update), the specific product or service involved, the stage of development or operation, the user or system credentials that generated the log(s) 318, timestamps and other features of the log(s) 318.

At block 1006, a target value corresponding to the log attribute(s) is compared with a tagged value corresponding to the attribute(s) associated with a retention criteria. In an example, the identification of retention criteria(s) involves analyzing the determined log attribute(s) of the log(s) and comparing them with corresponding attributes associated with predefined retention criteria stored in the repository. For example, the processing engine 312 compares a target value corresponding to the log attribute(s) 320 of the log(s) 318 with a corresponding tagged value of the attribute(s) which are previously associated with each retention criteria in the repository 214.

At block 1008, a relevant retention criteria is identified for managing the log, based on the comparison. For example, based on the comparison, the processing engine 312 identifies one or more relevant retention criteria for storing the log(s) 318 in the repository 214. In an example, the retention criteria(s) 322 identified for the log(s) 318 corresponds to a retention factor, which specifies a category of requirements that determine the retention period for the log(s) 318. These retention factors may include various conditions such as regional or location parameters, regulatory frameworks, industry practices, performance metrics, business needs, storing capabilities, data privacy related conditions, risk related factors, or a combination thereof.

At block 1010, an evaluation factor corresponding to the retention criteria is determined. In case of multiple retention criteria are identified as relevant for the log(s) 318, the processing engine 312 determines an evaluation factor corresponding to each retention criteria which are identified as relevant for storing the log(s) 318. In one example, the evaluation factor may be a priority factor(s) 324. The priority factor(s) 324 corresponding to each retention criteria may be prescribed based on a relative impact, relevance or any other factors indicating or prescribing one or more consequences for non-compliances.

At block 1012, the retention criteria is applied to the log. For example, the processing engine 312 applies the identified retention criteria(s) 322 to the log(s) 210. Such application of retention criteria(s) 322 may involve several actions. For example, the processing engine 312 may tag or associate the log(s) 318 with metadata indicating the specific retention criteria(s) 322 to be applied to obtain managed log(s) 326. In an example, the retention criteria(s) 322 may be applied based on the evaluation factor, such as the priority factor associated therewith. For example, retention criteria having highest priority factor may be applied to the log(s) 318, to provide managed log(s) 326. The system 216 may then store the managed log(s) 326 in a designated location within the repository 214 that corresponds to its retention criteria requirements. For example, the system 216 transmits the managed log(s) 326 (or managed log(s) 218 as depicted in FIG. 2) to the repository 214 for storage. In another example, as part of application of retention criteria(s) 322, the processing engine 312 may implement access controls based on the retention criteria, ensuring that only authorized personnel may view or modify the managed log(s) 326 during its retention period.

FIG. 11 illustrates another method 1100 for modifying a retention criteria associated with a log, as per an example. The order in which the above-mentioned method is described is not intended to be construed as a limitation, and some of the described method blocks may be combined in a different order to implement the method, or an alternative method.

Furthermore, the above-mentioned method 1100 may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a log retention system, such as system 506, or system 216, or system 804. In an implementation, the method may be performed under an “as a service” delivery model, where the system 506 or system 216 or system 804, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 1102, a request from a user to change a first retention period is received. For example, when a user, such as user 502, wishes to modify the retention criteria of a log, the user request 522 is initiated by the user 502 through the computing device 504 to be transmitted to the system 506 to modify a retention criteria of a log. In an example, the user request 522 includes the log ID 524 to identify specific log or group of logs from the repository 508 whose retention criteria is being requested for modification, and the updated retention field 526 indicating a second retention period corresponding to a second retention criteria. The log ID 524 and updated retention field 526 mentioned in user request 522 are stored in the system 506 in data 510 as log ID 512 and second retention period 516.

Upon receiving the user request 522, the system 506 identifies relevant log(s) 528 from the repository 508 corresponding to the log ID 512. The system 506 retrieves these logs along with their initial retention criteria(s) 530. As shown in FIG. 5, the initial retention criteria(s) 530 includes a first retention criteria (RC₁) related to regulatory framework with a 6-month retention period. The user request 522 seeks to change this to a new retention criteria, i.e., the second retention criteria 532 related to operations with a 9-month retention period.

At block 1104, a second retention period is compared with a first retention period. For example, the system 506 compares the first retention period 514 with the second retention period 516. If in case, the first retention period 514 is similar to the second retention period 516, the system 506 maintains the existing retention criteria, i.e., the initial retention criteria(s) 530 for the relevant log(s) 528 without implementing the requested change. On the other hand, when the first retention period 514 is different from the second retention period 516, the system 506 determines that a conflict may arise between the first retention criteria and the second retention criteria on changing the retention period of the log. For example, as depicted in FIG. 5, the first retention period 514 corresponding to the first retention criteria (which is already associated with the log) is 6 months and the second retention period 516 corresponding to the second retention period is 9 months. To this end, the system 506 determines that conflict between the first retention criteria and the second retention criteria may be present.

At block 1106, a determination is performed to ascertain whether the second retention period is different from the first retention period. For example, based on the comparison, the system 506 determines whether the second retention period 516 is different from the first retention period 514 or same. On determining that that the second retention period 516 is similar to the first retention period 514, the method proceeds to block 1108 (“Yes” path from block 1106). On the other hand, on determining that the second retention period 516 is not similar to the first retention period 514, the method proceeds to block 1110 (“No” path from block 1106).

At block 1108, the request received from the user is denied. For example, on determining that the second retention period 516 (the proposed retention period) is similar to that of first retention period 514 (existing retention period), the system 506 deny the user request to change the retention criteria as it may does not affect the retention period of the log(s).

At block 1110, the first priority factor is compared with the second priority factor to determine a conflict between the two. For example, on determining that the first retention period 514 is not similar to the second retention period 516, to confirm the conflict between the retention criteria, the system 506 determines the first priority factor 518 corresponding to the first retention criteria and the second priority factor 520 corresponding to the second retention criteria. In an example, the first priority factor 518 and the second priority factor 520 are determined based on the relative impact, or relevance, or any other factors indicating or prescribing one or more consequences for non-compliances. Once the priority factors are determined, the system 506 compares the first priority factor 518 with the second priority factor 520.

At block 1112, a determination is made to ascertain whether the first priority factor is greater than the second priority factor. For example, based on the comparison of the first priority factor 518 and the second priority factor 520, the system 506 determines whether the requested change in retention criteria is permissible or not. On determining that the first priority factor 518 is greater than the second priority factor 520, the method proceeds to block 1108 (“Yes” path from block 1112). On the other hand, on determining that the first priority factor 518 is less than the second priority factor 520, the method proceeds to block 1114 (“No” path from block 1112).

At block 1114, the second retention period corresponding to the second retention criteria is associated with the log. For example, on determining that the first priority factor 518 is less than the second priority factor 520, the system 506 proceeds to replace the first retention criteria by associating the second retention criteria with the relevant log(s) 528. For example, as depicted in FIG. 6, since the first priority factor 518, i.e., 1 is lower than the second priority factor 520, i.e., 2, the initial retention criteria(s) 530 is updated to updated retention criteria(s) 602 with second retention criteria 532 associated with the relevant log(s) 528 and the first retention criteria is discarded or disassociated from the relevant log(s) 528.

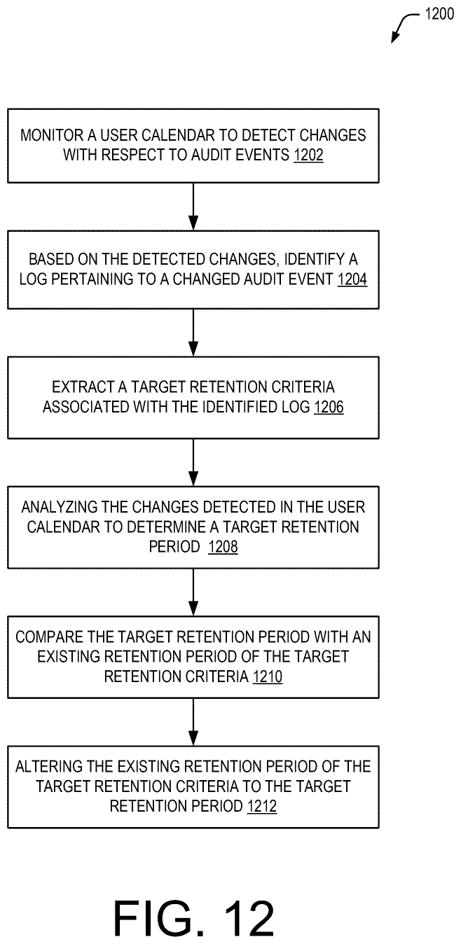

FIG. 12 illustrates another method 1200 for modifying a retention criteria associated with a log, as per an example. The order in which the above-mentioned method is described is not intended to be construed as a limitation, and some of the described method blocks may be combined in a different order to implement the method, or an alternative method.

Furthermore, the above-mentioned method 1200 may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a log retention system, such as system 804, or system 216, or system 506. In an implementation, the method may be performed under an “as a service” delivery model, where the system 804 or system 216 or system 506, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

As described above as well, audit events play a crucial role in ensuring compliance and quality throughout a lifecycle, such as lifecycle 202, of a product or a service. These events, which may include regulatory inspections, quality assurance reviews, or internal compliance checks, rely on logs that serve as audit trails. These logs capture detailed information about processes, decisions, and actions taken during development and operations of product or service. In industries such as pharmaceuticals, medical devices, or aerospace, prescribed audit procedures are established for different stages of development or operation. When followed correctly, logs capture details of each step, including timestamps, responsible personnel, and outcomes. Conversely, logs also record deviations or issues when procedures are not followed correctly.

To conduct audit events as per a timeline, relevant logs or audit trail must be retained for a required period. However, retention periods may need adjustment based on changes in audit schedules, which can occur due to various reasons such as regulatory body scheduling changes or internal resource allocation adjustments. For example, if a regulatory inspection is rescheduled to a later date, the retention period for relevant logs may need to be extended. Conversely, if an internal audit is moved earlier, the system must ensure all relevant logs are immediately accessible and not at risk of deletion under previous retention policies. To do the same, a user calendar is monitored to detect changes in upcoming audit events and accordingly retention criteria are modified to maintain logs or audit trails for appropriate time period.

At block 1202, a user calendar is monitored to detect changes with respect to audit processes. For example, the system 804 continuously monitors the user calendar 810 for detecting changes with respect to audit events or processes. In an example, the user calendar 810 includes information related to scheduled audit processes. In an example, a user, e.g., an auditor, operating on the computing device 802 keeps a track on all audit events via the user calendar 810. Once the changes are detected within the user calendar 810, the parsing engine 808 parses the user calendar 810 to identify the type of changes. Examples of changes in the user calendar 810 includes, but are not limited to, scheduling of a new audit process, a modification of an existing audit event, and cancellation of a scheduled audit event.

At block 1204, based on the detected changes, a log pertaining to a changed audit event is identified. For example, the parsing engine 808 identifies a relevant log pertaining to a changed audit event by analyzing the nature and timing of the audit event along with the content and metadata of stored logs. For example, if a regulatory compliance audit for a medical device is rescheduled, the parsing engine 808 may search for logs containing specific keywords or tags related to that device's manufacturing process, quality control tests, regulatory submissions, etc. In another example, the parsing engine 808 may use predefined rules or machine learning algorithms to assess log relevance, considering factors such as log's origin, quality assurance department), associated product codes, or regulatory identifiers.

At block 1206, a target retention criteria associated with the identified log is extracted. For example, the parsing engine 808 extracts the target retention criteria 814 relevant to the identified log. In an example, based on the identified log, the parsing engine 808 extracts the target retention criteria 814 from the repository 806 which is associated with the identified log. In one example, the repository 806 includes a look up table mapping log(s) with corresponding retention criteria associated with them. While changing or updating the existing retention criteria of identified log based on the changes detected in the user calendar 810, a conflict may arise. In such cases, as described in conjunction with FIG. 5, the system 804 or system 506 performs a conflict determination to ensure that changing the retention period does not create conflicts. This conflict check may be based on various evaluation factors, such as priority factors assigned to each retention criteria, user credential of the user, and system capabilities.

At block 1208, the changes detected in the user calendar are analyzed to determine a target retention period. For example, the parsing engine 808 analyzes the changes detected in the user calendar 810 to determine the target retention period 816 for the extracted target retention criteria 814. For example, when a change is detected in the user calendar 810, such as rescheduling an FDA inspection from September (9th month) to December (12th Month), the parsing engine 808 determines the target retention period 816 as 12 months.

At block 1210, the target retention period is compared with an existing retention period of the target retention criteria. For example, the parsing engine 808 compares the target retention period 816 with the existing retention period 818 of the target retention criteria 814. In an example, the existing retention period 818 is a retention period for which the logs are currently being retained in the repository 806.

At block 1212, the existing retention period of the target retention criteria is altered to the target retention period. For example, based on the comparison, when it is determined that the target retention period 816 is greater than or equal to the existing retention period 818, the parsing engine 808 initiates the process to alter the existing retention period 818 by lengthening it to the target retention period 816. On the other hand, when it is determined that the target retention period 816 is less than the existing retention period 818, the parsing engine 808 initiates the process to alter the existing retention period 818 by shortening it to the target retention period 816.

In an example, a pharmaceutical company maintains logs of its drug manufacturing processes and specified existing retention criteria as 5 years. In case, the system 804 detects a change in the user calendar that a regulatory audit which was scheduled for June 2024 has been moved to December 2024. The system 804 analyzes this change and determines that the relevant logs now need to be retained for 5.5 years to cover the new audit date. Since the target retention period 816 exceeds the existing retention period 818, the system lengthens the existing retention period to 5.5 years for the relevant logs.

On the other hand, if the audit had been moved earlier, e.g., to March 2024, resulting in a target retention period of 4.75 years, the system 804 would shorten the existing retention period from 5 years to 4.75 years.

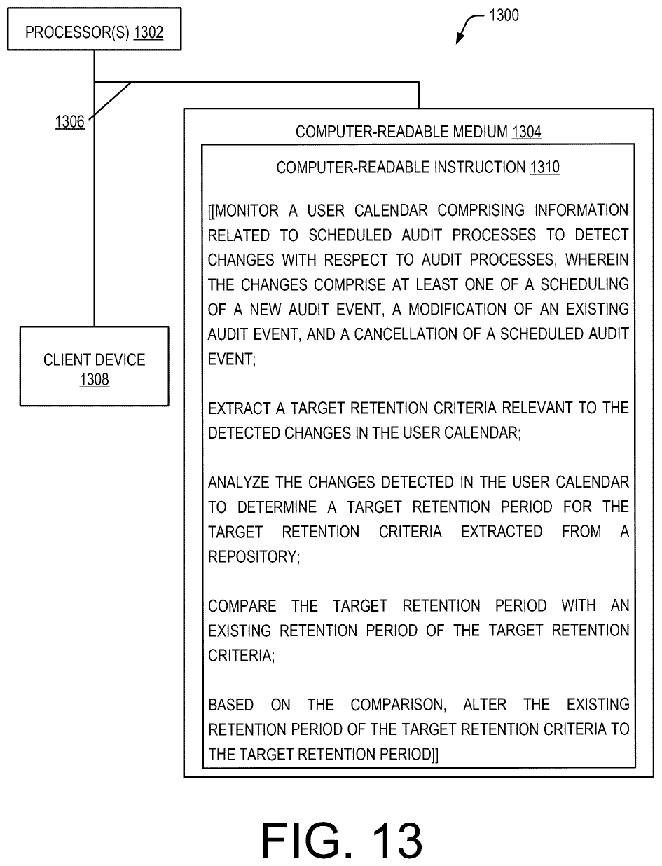

FIG. 13 illustrates a computing environment 1300 implementing a non-transitory computer readable medium for monitoring a user calendar to detect changes within the user calendar to modify a retention criteria of a log. In an example, the computing environment 1300 includes processor(s) 1302 communicatively coupled to a non-transitory computer readable medium 1304 through a communication link 1306. In an example implementation, the computing environment 1300 may be for example, the environment 800. In an example, the processor(s) 1302 may have one or more processing resources for fetching and executing computer-readable instructions from the non-transitory computer readable medium 1304. The processor(s) 1302 and the non-transitory computer readable medium 1304 may be implemented, for example, in system 804 (as has been described in conjunction with the preceding figures).

The non-transitory computer readable medium 1304 may be, for example, an internal memory device or an external memory device. In an example implementation, the communication link 1306 may be a network communication link. The processor(s) 1302 and the non-transitory computer readable medium 1304 may also be communicatively coupled to a computing device 1308 over the network.

In an example implementation, the non-transitory computer readable medium 1304 includes a set of computer readable instructions 1310 (referred to as instructions 1310) which may be accessed by the processor(s) 1302 through the communication link 1306. Referring to FIG. 13, in an example, the non-transitory computer readable medium 1304 includes instructions 1310 that cause the processor(s) 1302 to monitor a user calendar, such as user calendar 810, to detect changes with respect to upcoming audit events. Examples of such changes include, but are not limited to, scheduling of a new audit process, a modification of an existing audit event, and cancellation of a scheduled audit event.

Generally, the user calendar (e.g., the user calendar 810) depicts a graphical interface that displays days, weeks, or months in a grid format. It may allow users to create, view, and manage events, appointments, and deadlines related to various aspects of product or service development, operations, and compliance activities. Users may have the ability to set reminders, schedule recurring events, and share calendars with other team members or departments. The calendar may also integrate with other systems, such as system 804, automatically updating retention periods for relevant logs based on changes in scheduled audit events or compliance deadlines.

Continuing further, once the changes in upcoming audit events have been detected, the instructions 1310 may further cause a relevant pertaining to a changed audit event be identified from the repository, such as repository 806. In an example, the relevant log is identified by analyzing the nature and timing of the audit event along with the content and metadata of stored logs. For example, if a regulatory compliance audit for a medical device is rescheduled, a search for logs containing specific keywords or tags related to that device's manufacturing process, quality control tests, regulatory submissions, etc are identified.

Once the log(s) are identified, the instructions 1310 when executed are to extract a target retention criteria which is relevant or associated with the identified log(s). In an example, the target retention criteria 814 which is associated with identified log(s) are identified from the repository 806. In an example, the target retention criteria 814 indicate the retention criteria which is already applied to the identified log(s). The target retention criteria 814 has been extracted from the repository 806 to be modified accordingly based on the changes detected in audit event. While changing or updating the existing retention criteria of identified log based on the changes detected in the user calendar 810, a conflict may arise. In such cases, the instructions 1310 may cause to performs a conflict determination to ensure that changing the retention period of existing retention criteria does not create conflicts, either with its own retention period or retention period of other retention criteria. This conflict check may be based on various evaluation factors, such as priority factors assigned to each retention criteria, user credential of the user, and system capabilities.

Once it is determined that there are no conflicts, the instructions 1310 may cause to analyze the changes detected in the user calendar 810 to determine a target retention period, such as target retention period 816 for the extracted target retention criteria 814. For example, when a change is detected in the user calendar 810, such as rescheduling an FDA inspection from September (9th month) to December (12th Month), the parsing engine 808 determines the target retention period 816 as 12 months.

The instructions 1310, on determining the target retention period 816, may compare it with existing retention period 818 of the target retention criteria 814 to determine the extent to which existing retention period 818 are to be modified, either by extending the period or shortening the period. In an example, the existing retention period 818 is a retention period for which the logs are currently being retained in the repository 806.

Based on the comparison, the instructions 1310 may cause to modify the existing retention period of the target retention criteria. In an example, when it is determined that the target retention period 816 is greater than or equal to the existing retention period 818, the parsing engine 808 initiates the process to alter the existing retention period 818 by lengthening it to the target retention period 816. On the other hand, when it is determined that the target retention period 816 is less than the existing retention period 818, the parsing engine 808 initiates the process to alter the existing retention period 818 by shortening it to the target retention period 816. In this way, the present approaches allow for maintaining log(s) or audit trail of log(s) for appropriate time period without affecting the storage resources.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

What is claimed is:

1. A system comprising:
a processor; and
a machine-readable storage medium comprising instructions executable by the processor to:
obtain a log pertaining to one of an operation and a development, of one of a product and a service, wherein the one of the operation and the development is implemented using an executable-instructions based system;
process the log to determine an attribute pertaining to one of the operation and development;
identify, based on the determined attribute, a retention criteria for the log specifying a retention period for retaining the log in a repository; and
cause to apply the identified retention criteria for maintaining the log in the repository.

2. The system of claim 1, wherein the retention criteria corresponds to a retention factor, the retention factor specifying a category of requirements that are to specify the retention period for the log, and wherein the retention factor comprises conditions pertaining to a regional or location parameter, a regulatory framework, industry practices, performance metric, business needs, storing capabilities, data privacy related conditions, risk related factors, or combination thereof.

3. The system of claim 1, wherein to identify the retention criteria, the instructions are executable to:
compare a target value corresponding to the attribute of the log, with a corresponding tagged value of the attribute associated with each one of the retention criteria stored in the repository; and
based on the comparison, identify the retention criteria for maintaining the log in the repository.

4. The system of claim 1, wherein a priority factor is associated with the retention criteria based on a relative impact of the retention criteria in relation to the other retention criteria.

5. The system of claim 1, wherein the instructions are executable to:
obtain a training dataset comprising a log attribute pertaining to a log and corresponding retention criteria, wherein the log attribute comprises at least one of log type, content, source, timestamp, associated product or service, development state, operational context, and regulatory requirements; and
train a machine learning model using the training dataset, wherein the machine learning model, when trained, is to provide a retention criteria for an input log based on log attribute corresponding to the input log.

6. The system of claim 5, wherein the instructions are executable to:
determine a log attribute for the input log;
input the log attribute into the trained machine learning model to receive a predicted retention criteria as output for maintaining the input log, wherein the predicted retention criteria comprise a retention period, a storage location, and archival requirements; and
apply the predicted retention criteria to the input log for maintaining the input log in the repository.

7. The system of claim 1, wherein the log is one of a batch production record, equipment usage and maintenance logs, quality control text results, product release approvals, corrective and preventive action (CAPA) events, supplier qualification assessment, regulatory submission tracking, adverse events reports, product complaint handling, electronic signature records, formulation change records, clinical trial data entries, stability testing results, method validation documentation, technology transfer activities, design control milestones, risk assessment updates, software validation records, and user equipment specifications.

8. A method comprising:
receiving a request from a user to change a first retention period corresponding to a first retention criteria associated with a log, wherein the request comprises a second retention period corresponding to a second retention criteria;
determining a conflict between the first retention criteria and the second retention criteria based on an evaluation factor; and
on determining that the first retention criteria does not conflict with the second retention criteria, associating the second retention period corresponding to the second retention criteria with the log.

9. The method of claim 8, wherein the evaluation factor is one of a priority factor associated with respective retention criteria, user credential of the user, and system capability.

10. The method of claim 8, wherein the determining the conflict comprises:
comparing the second retention period corresponding to the second retention criteria with the first retention period corresponding to the first retention criteria; and
on determining the second retention period to be different from the first retention period, establishing a conflict between the first retention criteria and the second retention criteria.

11. The method of claim 10, wherein upon establishing the conflict between the first retention criteria and the second retention criteria, the method further comprises:
comparing a first priority factor, associated with the first retention criteria, and a second priority factor associated with a second retention criteria, wherein the priority factor corresponding to each retention criteria is prescribed based on a relative impact of each retention criteria in relation to the other retention criteria; and
based on the comparison, on determining first priority factor to be greater than the second priority factor, denying the request to alter the first retention period.

12. The method of claim 11, wherein the method further comprises:
on determining the first priority factor to be less than the second priority factor, associating the second retention period corresponding to the second retention criteria with the log.

13. The method of claim 12, wherein upon determining the first priority factor to be less than the second priority factor, the method further comprises:
evaluating an impact of the requested change on the operation and development of one of the products and the service; and
based on the evaluation, associating the second retention period corresponding to the second retention criteria with the log.

14. The method of claim 13, wherein to evaluate the impact of the requested change, the method comprises:
causing to render on a display device, a cost impact based on the evaluation of the impact of the requested changes on an operation and a development of one of a product and a service; and
receiving confirmation from the user, through a user interface rendered on the display device, to proceed with the requested change pursuant to the rendering of cost impact.

15. The method of claim 8, wherein the retention criteria correspond to a retention factor, the retention factor specifying a category of requirements that determines the retention period for the log, wherein the retention factor comprises conditions pertaining to a regional or location parameter, a regulatory framework, industry practices, performance metric, business needs, storing capabilities, data privacy related conditions, risk related factors, or combination thereof.

16. The method of claim 8, wherein upon associating the second retention criteria to the log, the method further comprises:
determining a current age of the log based on a timestamp indicating origination date and time of the log;
comparing the current age of the log with the second retention period corresponding to the second retention criteria; and
on determining the current age of the log to exceed the second retention period, deleting the log from the repository.

17. A non-transitory computer-readable medium comprising instructions, the instructions being executable by a processing resource of a system, to:
monitor a user calendar comprising information related to scheduled audit events to detect changes with respect to audit events, wherein the changes comprise at least one of a scheduling of a new audit event, a modification of an existing audit event, and cancellation of a scheduled audit event;
extract a target retention criteria relevant to the detected changes in the user calendar;
analyze the changes detected in the user calendar to determine a target retention period for the target retention criteria extracted from a repository;
compare the target retention period with an existing retention period of the target retention criteria; and
based on the comparison, alter the existing retention period of the target retention criteria to the target retention period.

18. The non-transitory computer-readable medium of claim 17, wherein the instructions being executable are to:
on determining the target retention period to exceed or equal to the existing retention period, alter by lengthening the existing retention period to the target retention period; or
on determining the target retention period to be less than the existing retention period, alter by shortening the existing retention period to the target retention period.

19. The non-transitory computer-readable medium of claim 17, wherein to extract a target retention criteria, the instructions being executable are to:
based on the detected changes, identify a log pertaining to a changed audit event; and
extract, from the repository, the target retention criteria associated with the identified log.

20. The non-transitory computer-readable medium of claim 17, wherein the retention criteria corresponds to a retention factor, the retention factor specifying a category of requirements that determines the retention period for the log, wherein the retention factor comprises conditions pertaining to a regional or location parameter, a regulatory framework, industry practices, performance metric, business needs, storing capabilities, data privacy related conditions, risk related factors, or combination thereof.

21. A method comprising:
obtaining, by one or more processors, a log pertaining to one of an operation and a development, of one of a product and a service;
processing, by the one or more processors, the log to determine an attribute pertaining to one of the operation and development;
identifying, based on the determined attribute, a retention criteria for the log specifying a retention period for retaining the log in a repository; and
applying the identified retention criteria for maintaining the log in the repository.

22. The method of claim 21, wherein the retention criteria corresponds to a retention factor, the retention factor specifying a category of requirements that are to specify the retention period for the log, and wherein the retention factor comprises conditions pertaining to a regional or location parameter, a regulatory framework, industry practices, performance metric, business needs, storing capabilities, data privacy related conditions, risk related factors, or combination thereof.

23. The method of claim 21, wherein to identify the retention criteria, the instructions are executable to:
comparing a target value corresponding to the attribute of the log, with a corresponding tagged value of the attribute associated with each one of the retention criteria stored in the repository; and
based on the comparison, identify the retention criteria for maintaining the log in the repository.

24. The method of claim 21, wherein a priority factor is associated with the retention criteria based on a relative impact of the retention criteria in relation to the other retention criteria.

25. The method of claim 21, wherein the instructions are executable to:
obtaining a training dataset comprising a log attribute pertaining to a log and corresponding retention criteria, wherein the log attribute comprises at least one of log type, content, source, timestamp, associated product or service, development state, operational context, and regulatory requirements; and
training a machine learning model using the training dataset, wherein the machine learning model, when trained, is to provide a retention criteria for an input log based on log attribute corresponding to the input log.

26. The method of claim 25, wherein the instructions are executable to:
determining a log attribute for the input log;
inputting the log attribute into the trained machine learning model to receive a predicted retention criteria as output for maintaining the input log, wherein the predicted retention criteria comprise a retention period, a storage location, and archival requirements; and
applying the predicted retention criteria to the input log for maintaining the input log in the repository.

27. The method of claim 21, wherein the log is one of a batch production record, equipment usage and maintenance logs, quality control text results, product release approvals, corrective and preventive action (CAPA) events, supplier qualification assessment, regulatory submission tracking, adverse events reports, product complaint handling, electronic signature records, formulation change records, clinical trial data entries, stability testing results, method validation documentation, technology transfer activities, design control milestones, risk assessment updates, software validation records, and user equipment specifications.

28. A non-transitory computer-readable medium containing instructions that, when executed by one or more processors, causes the one or more processors to perform operations comprising:
obtaining, by one or more processors, a log pertaining to one of an operation and a development, of one of a product and a service, wherein the one of the operation and the development is implemented using an executable-instructions based system;
processing, by the one or more processors, the log to determine an attribute pertaining to one of the operation and development;
identifying, based on the determined attribute, a retention criteria for the log specifying a retention period for retaining the log in a repository; and
applying the identified retention criteria for maintaining the log in the repository.

29. The non-transitory computer-readable medium of claim 28, wherein the retention criteria corresponds to a retention factor, the retention factor specifying a category of requirements that are to specify the retention period for the log, and wherein the retention factor comprises conditions pertaining to a regional or location parameter, a regulatory framework, industry practices, performance metric, business needs, storing capabilities, data privacy related conditions, risk related factors, or combination thereof.

30. The non-transitory computer-readable medium of claim 28, wherein to identify the retention criteria, the instructions are executable to:
comparing a target value corresponding to the attribute of the log, with a corresponding tagged value of the attribute associated with each one of the retention criteria stored in the repository; and
based on the comparison, identify the retention criteria for maintaining the log in the repository.

31. The non-transitory computer-readable medium of claim 28, wherein a priority factor is associated with the retention criteria based on a relative impact of the retention criteria in relation to the other retention criteria.

32. The non-transitory computer-readable medium of claim 28, wherein the instructions are executable to:
obtaining a training dataset comprising a log attribute pertaining to a log and corresponding retention criteria, wherein the log attribute comprises at least one of log type, content, source, timestamp, associated product or service, development state, operational context, and regulatory requirements; and
training a machine learning model using the training dataset, wherein the machine learning model, when trained, is to provide a retention criteria for an input log based on log attribute corresponding to the input log.

33. The non-transitory computer-readable medium of claim 32, wherein the instructions are executable to:
determining a log attribute for the input log;
inputting the log attribute into the trained machine learning model to receive a predicted retention criteria as output for maintaining the input log, wherein the predicted retention criteria comprise a retention period, a storage location, and archival requirements; and
applying the predicted retention criteria to the input log for maintaining the input log in the repository.
